(19) United States
(12) Patent Application Publication
(10) Pub. No.: US 2013/0346024 A1
(43) Pub. Date: Dec. 26, 2013

(54) METHOD FOR FORECASTING WORK-IN-PROCESS OUTPUT SCHEDULE AND COMPUTER PROGRAM PRODUCT THEREOF

(71) Applicants: Haw-Ching YANG, TAINAN (TW); Chien-Yi CHAO, TAIPEI CITY (TW); Fan-Tien CHENG, TAINAN (TW)

(72) Inventors: Haw-Ching YANG, TAINAN (TW); Chien-Yi CHAO, TAIPEI CITY (TW); Fan-Tien CHENG, TAINAN (TW)

(73) Assignee: NATIONAL CHENG KUNG UNIVERSITY, TAINAN CITY (TW)

(21) Appl. No.: 13/561,096

(22) Filed: Jul. 30, 2012

(30) Foreign Application Priority Data
Jun. 22, 2012 (TW) 101122430

(51) Int. Cl. G06F 17/18; G06F 19/00

(52) U.S. Cl. 702/181

(57) ABSTRACT

A method for forecasting a WIP (work in process) output schedule and a computer program product thereof are provided. A plurality of sets of historical WIP data regarding a product generated in respective historical periods are first collected, in which the product has a maximum historical production cycle. Thereafter, a predetermined time is used to divide the maximum historical production cycle into intervals. Then, the quantities of historical WIPs appearing in the respective intervals are computed in accordance with output times of the historical WIPs recorded in each of the sets of historical WIP data, thereby obtaining output probability density data series. If the number of the historical periods is greater than or equal to a minimum model-building number, a predicted output probability density data series of a next period following the historical periods is conjectured by using the output probability density data series in accordance with a prediction algorithm.

### RELATED APPLICATIONS

The present application is based on, and claims priority from Taiwan Application Serial Number 101122430, filed Jun. 22, 2012, the disclosure of which is hereby incorporated by reference herein in its entirety.

### BACKGROUND

1. Field of Invention

The present invention relates to a method for forecasting a WIP (work in process) output schedule and a computer program product thereof. More particularly, the present invention relates to a method for forecasting a WIP output schedule for paired/unpaired WIP data and a computer program product thereof.

2. Description of Related Art

To control production outputs, a supplier (such as a wafer foundry) and a customer (such as a IC designer) use WIP information to monitor and to estimate the production progress, in which there are several models, e.g., customer management inventory (CMI) mode and collaborative planning, forecasting, and replenishment (CPFR) procedure, which have been proposed to agree upon a joint plan, to monitor replenishment, and to respond the recognized exceptions for the two trading partners (the supplier and the customer). Capability of mastering supplies is the key to success in realizing the trading models. If the customer lacks of confidence at on-time supplying, higher inventory levels and extra lead times could be used to prevent the production variations of the supplier side. Hence, the customer needs to collect the WIP information from its supplier and uses the information to monitor and forecast production outputs for making decision efficiently.

There are two types of methods for collecting the WIP information from the supplier, which are a snapshot type and a transaction type. The snapshot type only records output quantities by snapshot time but lacks of the corresponding relationships between input times (move-in times) and output times (move-out times), while the transaction type recording the input and output times by WIP transaction has the problem of tremendous data amount. The time difference between the data transmission (collection) frequency and the production cycle time will affect data resolution, thus resulting in paired and unpaired data types. Referring to FIG. 1, FIG. 1 is a schematic diagram showing a WIP data transmission (sampling) time ΔT and a production cycle time (inter-arrival period) Δt, wherein the production cycle time Δt stands for a time interval at which WIPs are moved in a process stage 100 or moved out from the process stage 100. When the data transmission (sampling) time ΔT of WIPs is greater than the production cycle time Δt at which the WIPs enters the process stage 100, there may exist a plurality of WIPs with the same ID entering the same process stage in WIP snapshot data, and thus the WIP data lose the corresponding relationships between WIP quantities and input/output time-stamps when the WIPs are moved in or moved out of the process stage in ΔT, and the WIP data in this situation is named as “unpaired WIP data”. On the other hand, when the data transmission (sampling) time ΔT of WIPs is smaller than or equal to the production cycle time Δt at which the WIPs enters the process stage 100, at most one WIP moved in or our from the process stage appears in the WIP data collecting period, and thus the output time of each WIP is corresponding to its input time, and the WIP data in this situation is named as “paired WIP data”.

Due to the aforementioned data difference, a conventional skill can only process the paired WIP data, and with respect to the unpaired WIP data, the conventional skill often can only use a basic method to estimate their production cycle times.

Hence, there is a need to provide a method for forecasting a WIP output schedule and a computer program product thereof for building a production time prediction model in accordance with the features of paired/unpaired WIP data, thereby achieving the purpose of conjecturing WIP production times.

### SUMMARY

An object of the present invention is to provide a method for forecasting a WIP output schedule and a computer program product thereof, thereby constructing a forecast scheme of WIP output timing and quantities for simultaneously processing paired and unpaired WIP data, thus achieving the purpose of commonly using a forecasting method for both types of WIP data.

According to an aspect of the present invention, a method for forecasting a WIP output schedule is provided. In this method, at first, a plurality of sets of historical WIP data regarding a product generated in a plurality of historical periods are respectively collected, wherein the product has a maximum historical production cycle time, and the historical periods have the same length, and each of the sets of historical WIP data comprises output times of a plurality of historical WIPs. Then, a predetermined time is used to divide the maximum historical production cycle into a plurality of intervals. Thereafter, quantities of the historical WIPs appearing in the respective intervals are computed in accordance with the output times of the historical WIPs (works in process) recorded in each of the sets of historical WIP data, thereby obtaining a plurality of output probability density data series regarding the product generated in the respective historical periods. If the number of the historical periods is greater than or equal to a minimum model-building number, a predicted output probability density data series in a next period following the historical periods is conjectured by using the plurality of output probability density data series in accordance with a prediction algorithm, wherein the predicted output probability density data series includes probabilities of WIPs outputted in the respective intervals. In one embodiment, the prediction algorithm is a regression algorithm, such as a grey prediction algorithm.

According to one embodiment, if the number of the historical periods is smaller than the minimum model-building number, the plurality of output probability density data series of the respective historical periods are cumulated and averaged for obtaining an average output probability density data series, and a WIP output time in the next period is computed by using the average output probability density data series in accordance with an expected value algorithm.

According to one embodiment, the minimum model-building number is 4.

According to one embodiment, if a sum of a plurality of elements in the predicted output probability density data series is greater than 1, each of the elements in the predicted output probability density data series is divided by the sum.

According to one embodiment, each of the sets of historical WIP data comprises input times of the historical WIPs. If the input times of the historical WIPs are not completely corresponding to the output times of the historical WIPs respectively in the sets of historical WIP data, namely unpaired WIP data, in which a WIP record cannot be used in modeling the cycle time of product when it fails to correlate with its input quantity and time or its output quantity and time, each of the elements in the predicted output probability density data series is multiplied by a total output amount of the historical WIPs in the last one of the historical periods, thereby obtaining a predicted output quantity data series including WIP quantities outputted in the respective intervals of the next period.

According to one embodiment, if the input times of the historical WIPs are respectively corresponding to the output times of the historical WIPs in the sets of historical WIP data, namely paired WIP data, the historical WIPs are the WIPs on which one of a plurality of material layers of the product is completed. Each of the elements in the predicted output probability density data series is multiplied by a total output amount of the historical WIPs on which the one of the material layers of the product is completed in the last one of the historical periods, thereby obtaining a predicted output quantity data series of the one of the material layers in the next period, wherein the predicted output quantity data series includes WIP quantities outputted in the respective intervals of the next period.

According to another aspect of the present invention, a computer program product is provided. When this computer program product is loaded and executed by a computer, the aforementioned method for forecasting a WIP output schedule is performed.

Hence, with the application of the embodiments of the present invention, a forecast scheme of WIP output timing and quantities for simultaneously processing paired and unpaired WIP data can be effectively built, thus achieving the purpose of commonly using a forecasting method for both types of WIP data.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing a WIP data transmission (sampling) time and a production cycle time (inter-arrival period); and

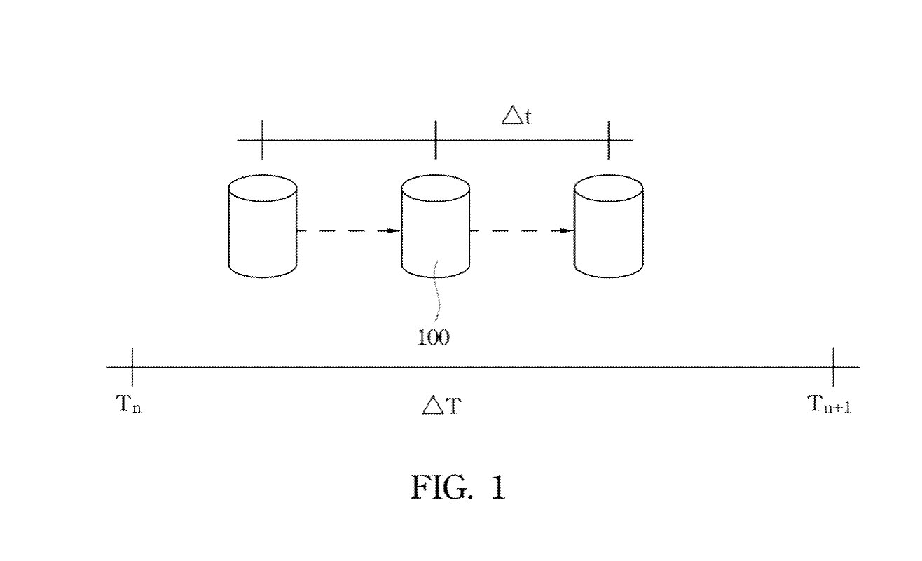

FIG. 2 is a flow chart showing method for forecasting a WIP output schedule according an embodiment of the present invention.

### DESCRIPTION OF THE PREFERRED EMBODIMENTS

Reference will now be made in detail to the embodiments of the present invention, examples of which are illustrated in the accompanying drawings. Wherever possible, the same reference numbers are used in the drawings and the description to refer to the same or like parts.

The present invention is directed to a method and a mechanism for conjecturing a WIP output schedule. The data used in the present invention are obtained by collecting situations of on-site WIPs, including WIP IDs, WIP quantities and process locations on which the WIPs are located, etc. The data collection method of the present invention can be a snapshot type or a transaction type, wherein the snapshot type records instant situations of on-site WIPs, and the transaction type records the times and quantities of WIPs moved in and out of respective processes, etc. The data processing method of the present invention is first based on a difference between a data collecting period and a process time, process features and historical behaviors, etc. to build a conjecturing model, and then forecasts the WIP output (production) time in accordance with the conjecturing model.

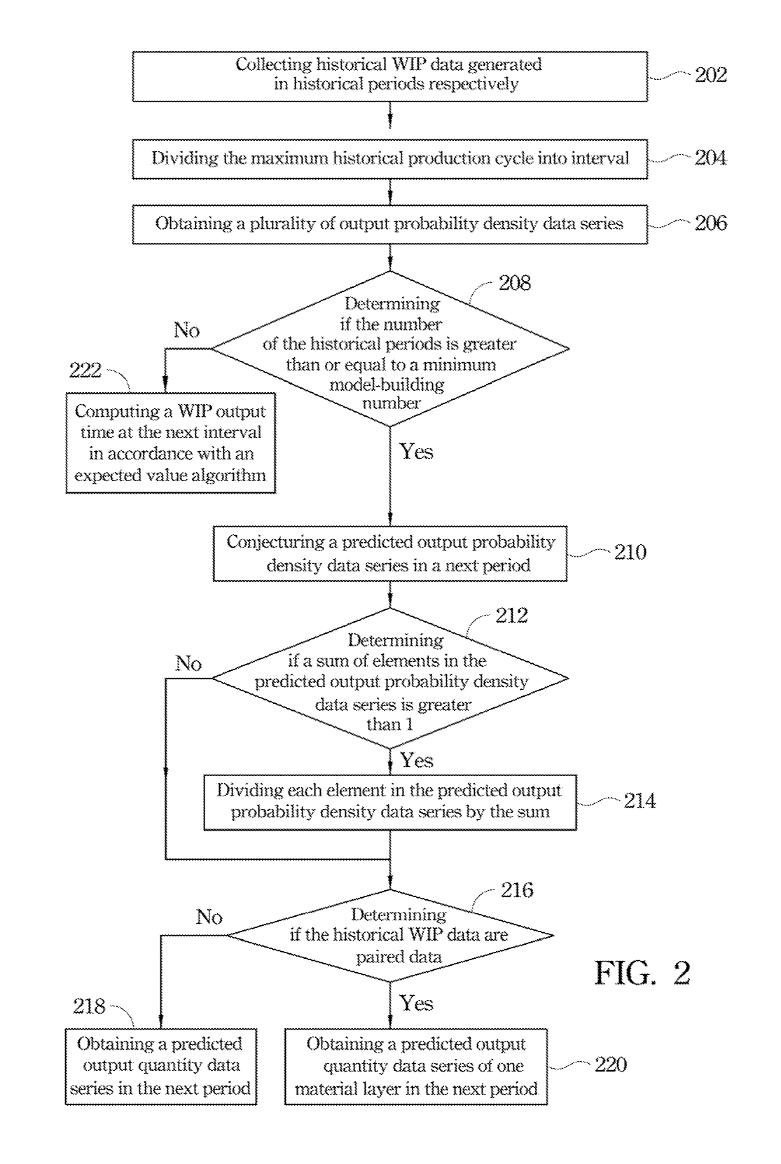

Referring to FIG. 2, FIG. 2 is a flow chart showing method for forecasting a WIP output schedule according an embodiment of the present invention. As shown in FIG. 2, at first, step 202 is performed for collecting a plurality of sets of historical WIP data regarding a product generated in a plurality of historical periods respectively, wherein the product has a maximum historical production cycle time, and the historical periods have the same length, and each of the sets of historical WIP data includes output times of a plurality of historical WIPs. For example, the maximum historical production cycle time of a certain product is 18 days, and four historical periods of WIP historical data are collected, wherein the length of each historical period is 18 days. Then, step 204 is performed for dividing the maximum historical production cycle into a plurality of intervals by a predetermined time. For example, the predetermined time is 2 days, and thus the maximum historical production cycle (18 days) can be divided into nine intervals.

Thereafter, step 206 is performed for computing quantities of the historical WIPs appearing in the respective intervals in accordance with the output times of the historical WIPs recorded in each set of historical WIP data, thereby obtaining a plurality of output probability density data series regarding the product generated in the respective historical periods. In general, the frequency of WIPs regarding the product appearing in the respective intervals of each historical period is shown as a histogram. For example, for the first historical period, the nine intervals are 0-2^{nd} day, 2^{nd}-4^{th} day, 4^{th}-6^{th} day, 4^{th}-6^{th} day, 6^{th}-8^{th} day, 8^{th}-10^{th} day, 10^{th}-12^{th} day, 12^{th}-14^{th} day, 14^{th}-16^{th} day and 16^{th}-18^{th} day, and the quantities of the WIPs appearing in the respective intervals are 27, 65, 46, 39, 33, 19, 23, 17, and 9, and the total WIP amount is 278. Hence, the output probability densities of the WIPs in the respective intervals of the first historical period are 27/278, 65/278, 46/278, 39/278, 33/278, 19/278, 23/278, 17/278, and 9/278, and thus the output probability density data series for the first historical period is x_{i,1}⁽⁰⁾={x_{1,1}⁽⁰⁾, x_{2,1}⁽⁰⁾, . . . , x_{9,1}⁽⁰⁾}={0.097, 0.234, 0.165, 0.140, 0.118, 0.068, 0.083, 0.061, 0.032}. In the same manner described above, the output probability densities of the WIPs in the respective intervals of the 2^{nd}-4^{th} historical periods, x_{i,2}⁽⁰⁾, x_{i,3}⁽⁰⁾, x_{i,4}⁽⁰⁾, can be obtained, wherein the superscript “0” stands for an original output probability density data series, and the subscript “i” stands for the 1^{st}-9^{th} interval.

Generally speaking, a prediction algorithm requires a certain number of historical periods of historical WIP data (i.e. enough “i”) for performing forecast. Therefore, step 208 is performed for determining if the number (“i”) of the historical periods is greater than or equal to a minimum number required for performing a prediction algorithm (i.e., a minimum model-building number, for example, 4). If the result of step 208 is yes, a predicted output probability density data series in a next period following the historical periods is conjectured by using the plurality of output probability density data series in accordance with the prediction algorithm (step 210), wherein the predicted output probability density data series includes probabilities of WIPs outputted in the respective intervals. In one embodiment, the prediction algorithm can be a regression algorithm, such as a grey prediction algorithm, but the present invention is not limited thereto. In general, the grey prediction algorithm requires four historical periods of WIP data to be applied for prediction.

Hereinafter, the 3^{rd} interval is used as an example for explaining step 210, wherein the 3^{rd} interval is a period between the 4th day and the 6th day. When four (historical) periods of historical WIP data are collected, the original output probability density data series in the appearing sequence of the historical periods are x₃⁽⁰⁾={x_{3,1}⁽⁰⁾,x_{3,2}⁽⁰⁾,x_{3,3}⁽⁰⁾,x_{3,4}⁽⁰⁾}={0.165, 0.151, 0.155, 0.158}.

Thereafter, an accumulated generating operation data series is computed by using the original output probability density data series in accordance with formula (1).

$${x}_{i , j}^{( 1 )} = {\sum }_{k = 1}^{j} {x}_{i , k}^{( 0 )} \qquad ( 1 )$$

According to equation (1), from x₃⁽⁰⁾, the accumulated generating operation data series x₃⁽¹⁾ for the 3rd interval can be computed as x₃⁽¹⁾={x_{3,1}⁽¹⁾,x_{3,2}⁽¹⁾,x_{3,3}⁽¹⁾,x_{3,4}⁽¹⁾}={0.165, 0.316, 0.471, 0.629}.

Thereafter, according to the grey prediction algorithm, the predicted output probability density data series in a next period following the historical periods can be conjectured from the accumulated generating operation data series of formula (1), wherein the grey prediction algorithm is shown as equations (2) to (4).

$$\begin{matrix}{z}_{i , j}^{( 1 )} = α \times {x}_{i , j}^{( 1 )} + ( 1 - α ) {x}_{i , j - 1}^{( 1 )} , \\ j = 2 , … , n , n \geq 4 & ( 2 ) \\ {\hat{x}}_{i , j + 1}^{( 0 )} = [ {x}_{i , 1}^{( 0 )} - \frac{b}{a} ] {e}^{- aj} + ( \frac{b}{a} ) , \\ j \geq 0 & ( 3 ) \\ a = \frac{C D - ( n - 1 ) E}{( n - 1 ) F - {C}^{2}} , b = \frac{D F - C E}{( n - 1 ) F - {C}^{2}} ; \\ C = {\sum }_{j = 2}^{n} {z}_{i , j}^{( 1 )} , D = {\sum }_{j = 2}^{n} {x}_{i , j}^{( 0 )} , E = {\sum }_{j = 2}^{n} {z}_{i , j}^{( 1 )} \times {x}_{i}^{( 0 )} , F = {\sum }_{j = 2}^{n} {( {z}_{i , j}^{( 1 )} )}^{2} ; & ( 4 )\end{matrix}$$

α is a Relaxation Factor, 0<α<1.

According to equation (2), from x₃⁽¹⁾, the accumulated generating operation data series z₃⁽¹⁾ for the 3rd interval can be computed as z₃⁽¹⁾={z_{3,1}⁽¹⁾,z_{3,2}⁽¹⁾,z_{3,3}⁽¹⁾,z_{3,4}⁽¹⁾}={0.165, 0.2405, 0.3935, 0.55}, and then according to equation (3), the (predicted) output probability density \hat{x}_{3,5}⁽⁰⁾ for the 3rd interval in the 5^{th} period (following the 4^{th} historical period) can be obtained as \hat{x}_{3,5}⁽⁰⁾=0.162.

When a linear regression algorithm, an exponential regression algorithm, and a second order polynomial regression algorithm are respectively adopted in the present example, the respective predicted values obtained thereby are 0.153, 0.1534 and 0.1753. Since, from the 2^{nd} historical period to the 4^{th} historical period, the original output probability density therein is first increased to 0.155 from 0.151 and then to 0.158, it can be observed that the WIP output in the 3^{rd} interval (from the 4^{th} day to the 6^{th} day) has increasing tendency, so that the output probability density (0.162) conjectured by the grey algorithm is more reasonable than those conjectured by the other regression algorithms. However, the other regression algorithms are also applicable to the present invention.

Further, after the predicted output probability density data series \hat{x}_{i,j+1}⁽⁰⁾ is obtained, step 212 is performed for determining if a sum of all of the elements in the predicted output probability density data series is greater than 1. If the result of step 212 is yes, each element in the predicted output probability density data series is divided by the sum (step 214). For example, if the output probability densities for the respective intervals in the 5^{th} period conjectured by the grey algorithm are \hat{x}_{i,5}⁽⁰⁾={\hat{x}_{1,5}⁽⁰⁾, \hat{x}_{2,5}⁽⁰⁾, . . . , \hat{x}_{9,5}⁽⁰⁾}={0.091, 0.212, 0.162, 0.131, 0.107, 0.091, 0.072, 0.051, 0.089}, since the sum of the respective elements (probability densities) in the data series is greater than 1, each of the probability densities is divided by the sum, and the output probability densities for the respective intervals in the 5^{th} period are obtained as {0.090, 0.211, 0.161, 0.130, 0.106, 0.090, 0.072, 0.051, 0.089}.

Thereafter, if the result of step 212 is no or step 214 is completed, step 216 is performed for determining if the sets of historical WIP data collected are paired data. Since each set of historical WIP data includes input times of the historical WIPs, if the input times of the historical WIPs are respectively corresponding to the output times of the historical WIPs, the sets of historical WIP data collected are paired data; If the input times of the historical WIPs are not completely corresponding to the output times of the historical WIPs respectively, the sets of historical WIP data collected are unpaired data.

If the result of step 216 is no, meaning that the sets of historical WIP data collected are unpaired data, step 218 is performed for multiplying each of the elements in the predicted output probability density data series by a total output amount of the historical WIPs in the last one (for example, the 4^{th} historical period) of the historical periods, thereby obtaining a predicted output quantity data series in the next period (for example, the 5^{th} historical period) following the historical periods, wherein the predicted output quantity data series includes WIP quantities outputted in the respective intervals of the next period following the historical periods. For example, if the total output amount of the historical WIPs in the 4^{th} historical period is 120, the quantities of the WIPs appearing in the respective intervals {0-2, 2-4, 4-6, 6-8, 8-10, 10-12, 12-14, 14-16, 16-18} are {11, 26, 19, 16, 13, 10, 8, 7, 10}.

If the result of step 216 is yes, meaning that the sets of historical WIP data collected are paired data, the historical WIPs are the WIPs on which one of a plurality of material layers of the product is completed, such as the WIPs in a front-end process. Therefore, step 220 is performed for multiplying each of the elements in the predicted output probability density data series by a total output amount of the historical WIPs on which the one of the material layers of the product is completed in the last one of the historical periods, thereby obtaining a predicted output quantity data series of the one of the material layers in the next period, wherein the predicted output quantity data series includes WIP quantities outputted in the respective intervals of the next period.

For example, if the maxim number of material layers of a certain product is 25 and the WIP data are recorded in a countdown manner, the product WIP is denoted the maximum number of material layers when just entering a production line, and is denoted 0 as the final material layer. For each material layer, if more than four historical periods of historical data can be collected and the historical periods have the same length, the WIP output quantities of the material layer of the product in the respective intervals can be predicted according to the total output amount of the WIPs in the previous historical period after several simulations and averaging the numbers in the respective intervals. For example, if the maximum historical production cycle time of the 8^{th} material layer of a certain product is 4.5 days; the interval is 0.5 day (meaning that there are nine intervals (4.5/0.5); the total output amount of the WIPs of the 8^{th} material layer in the 4^{th} historical period is 30; and the output probability densities for the respective intervals in the 5^{th} period conjectured by the grey algorithm are {0.090, 0.211, 0.161, 0.130, 0.106, 0.090, 0.072, 0.051, 0.089}, the quantities of the WIPs appearing in the respective intervals {0-0.5, 0.5-1, 1-1.5, 1.5-2, 2-2.5, 2.5-3, 3-3.5, 3.5-4, 4-4.5} are {3, 6, 5, 4, 3, 3, 2, 2, 3}.

On the other hand, if the result of step 208 is yes, i.e. the number of the historical periods is smaller than the minimum model-building number, the grey algorithm cannot be used, and step 222 is performed for cumulating and averaging the plurality of output probability density data series in the respective historical periods for obtaining an average output probability density data series, and a WIP output time \hat{θ}_{p,k+1} in the next period is computed by using the average output probability density data series in accordance with an expected value algorithm, wherein the expected value algorithm is shown as equation (5).

$${\hat{θ}}_{p , k + 1} = {E ( x )}_{k} = {\sum }_{i = 1}^{m} {x}_{i} P ( x = {x}_{i} ) \qquad ( 5 )$$

For example, if less than four periods of historical WIP data of the product are accumulated, and its WIP output probability densities in the respective intervals are x_{i,1}⁽⁰⁾={x_{1,1}⁽⁰⁾, x_{2,1}⁽⁰⁾, . . . , x_{9,1}⁽⁰⁾}={0.097, 0.234, 0.165, 0.141, 0.118, 0.068, 0.083, 0.061, 0.033}, it can be obtained from equation (5) that the historical expected value is 6.976 days, so that the production cycle time for the 5^{th} period is also set as 6.976 days. If the total WIP amount in the previous period, the output times of all of the WIPs on the production line are assumed to be 6.976 days after being inputted into the production line.

Further, if the historical WIP data collected are paired data, the grey algorithm, the expected value algorithm or a predetermined value can be adopted in accordance with the amount of the WIP data accumulated to conjecture the production cycle time required for other material layers of the product. For example, if there are more than four periods of WIP historical data of the 8^{th} and 3^{rd} material layers, the grey algorithm can be used to conjecture the WIP quantity of the next period (the 5^{th} period). If the respective amounts of WIP historical data of the 7^{th}, 5^{th} and 2^{nd} material layers are not enough, the expected value algorithm is used to conjecture the production cycle times of those material layers in the next period (the 5^{th} period). When no historical data are available for the other material layers including the 6^{th}, 4^{th}. 1^{st}, 0^{th} material layers, the predetermined values are used to estimate the production cycle times of those material layers in the next period (the 5^{th} period). The final WIP output time in the next period (the 5^{th} period) is obtained by summing the aforementioned production cycle times (process times) of the respective material layers.

The aforementioned embodiments can be provided as a computer program product, which may include a machine-readable medium on which instructions are stored for programming a computer (or other electronic devices) to perform a process based on the embodiments of the present invention. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present invention also can be downloaded as a computer program product, which may be transferred from a remote computer to a requesting computer by using data signals via a communication link (such as a network connection or the like).

It can be known from the above that, with the application of the embodiments of the present invention, a forecast scheme of WIP output timing and quantities for simultaneously processing paired and unpaired WIP data can be effectively built, thus achieving the purpose of commonly using a forecasting method for both types of WIP data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for forecasting a WIP (work in process) output schedule, comprising:
collecting a plurality of sets of historical WIP data regarding a product generated in a plurality of historical periods respectively, wherein the product has a maximum historical production cycle time, and the historical periods have the same length, and each of the sets of historical WIP data comprises output times of a plurality of historical WIPs (works in process);
dividing the maximum historical production cycle into a plurality of intervals by a predetermined time;
computing quantities of the historical WIPs appearing in the respective intervals in accordance with the output times of the historical WIPs recorded in each of the sets of historical WIP data, thereby obtaining a plurality of output probability density data series regarding the product generated in the respective historical periods; and
if the number of the historical periods is greater than or equal to a minimum model-building number, conjecturing a predicted output probability density data series in a next period following the historical periods by using the plurality of output probability density data series in accordance with a prediction algorithm, the predicted output probability density data series comprising probabilities of WIPs outputted in the respective intervals.

2. The method as claimed in claim 1, wherein the prediction algorithm is a regression algorithm.

3. The method as claimed in claim 1, wherein the prediction algorithm is a grey prediction algorithm.

4. The method as claimed in claim 1, further comprising:
if the number of the historical periods is smaller than the minimum model-building number, cumulating and averaging the plurality of output probability density data series of the respective historical periods for obtaining an average output probability density data series, and computing a WIP output time in the next period by using the average output probability density data series in accordance with an expected value algorithm.

5. The method as claimed in claim 1, further comprising:
if a sum of a plurality of elements in the predicted output probability density data series is greater than 1, dividing each of the elements in the predicted output probability density data series by the sum.

6. The method as claimed in claim 1, wherein each of the sets of historical WIP data comprises input times of the historical WIPs;
if the input times of the historical WIPs are not completely corresponding to the output times of the historical WIPs respectively, each of the elements in the predicted output probability density data series is multiplied by a total output amount of the historical WIPs in the last one of the historical periods, thereby obtaining a predicted output quantity data series comprising WIP quantities outputted in the respective intervals of the next period.

7. The method as claimed in claim 1, wherein each of the sets of historical WIP data comprises input times of the historical WIPs;
if the input times of the historical WIPs are respectively corresponding to the output times of the historical WIPs, the historical WIPs are the WIPs on which one of a plurality of material layers of the product is completed.

8. The method as claimed in claim 7, further comprising:
multiplying each of the elements in the predicted output probability density data series by a total output amount of the historical WIPs on which the one of the material layers of the product is completed in the last one of the historical periods, thereby obtaining a predicted output quantity data series of the one of the material layers in the next period, the predicted output quantity data series comprising WIP quantities outputted in the respective intervals of the next period.

9. A computer program product, which, when executed, performs a method for forecasting a WIP output schedule, comprising:
collecting a plurality of sets of historical WIP data regarding a product generated in a plurality of historical periods respectively, wherein the product has a maximum historical production cycle time, and the historical periods have the same length, and each of the sets of historical WIP data comprises output times of a plurality of historical WIPs;
dividing the maximum historical production cycle into a plurality of intervals by a predetermined time;
computing quantities of the historical WIPs appearing in the respective intervals in accordance with the output times of the historical WIPs recorded in each of the sets of historical WIP data, thereby obtaining a plurality of output probability density data series regarding the product generated in the respective historical periods; and
if the number of the historical periods is greater than or equal to a minimum model-building number, conjecturing a predicted output probability density data series in a next period following the historical periods by using the plurality of output probability density data series in accordance with a prediction algorithm, the predicted output probability density data series comprising probabilities of WIPs outputted in the respective intervals.

10. The computer program product as claimed in claim 9, wherein the prediction algorithm is a regression algorithm.

11. The computer program product as claimed in claim 9, wherein the prediction algorithm is a grey prediction algorithm.

12. The computer program product as claimed in claim 9, wherein the method further comprises:
if the number of the historical periods is smaller than the minimum model-building number, cumulating and averaging the plurality of output probability density data series of the respective historical periods for obtaining an average output probability density data series, and computing a WIP output time in the next period by using the average output probability density data series in accordance with an expected value algorithm.

13. The computer program product as claimed in claim 9, wherein the method further comprises:
if a sum of a plurality of elements in the predicted output probability density data series is greater than 1, dividing each of the elements in the predicted output probability density data series by the sum.

14. The computer program product as claimed in claim 9, wherein each of the sets of historical WIP data comprises input times of the historical WIPs;
if the input times of the historical WIPs are not completely corresponding to the output times of the historical WIPs respectively, each of the elements in the predicted output probability density data series is multiplied by a total output amount of the historical WIPs in the last one of the historical periods, thereby obtaining a predicted output quantity data series comprising WIP quantities outputted in the respective intervals of the next period.

15. The computer program product as claimed in claim 1, wherein each of the sets of historical WIP data comprises input times of the historical WIPs;
if the input times of the historical WIPs are respectively corresponding to the output times of the historical WIPs, the historical WIPs are the WIPs on which one of a plurality of material layers of the product is completed.

16. The computer program product as claimed in claim 15, wherein the method further comprises:
multiplying each of the elements in the predicted output probability density data series by a total output amount of the historical WIPs on which the one of the material layers of the product is completed in the last one of the historical periods, thereby obtaining a predicted output quantity data series of the one of the material layers in the next period, the predicted output quantity data series comprising WIP quantities outputted in the respective intervals of the next period.
